(19) United States
(12) Patent Application Publication
(10) Pub. No.: US 2014/0380479 A1
(43) Pub. Date: Dec. 25, 2014

(54) Method and System for Controlling Closing of Terminal, and Computer Storage Medium

(71) Applicant: Tencent Technology (Shenzhen) Company Limited, Guangdong (CN)

(72) Inventors: Hui Huang, Guangdong (CN); Yinghao Zhang, Guangdong (CN); Qiru Chen, Guangdong (CN); Shiping Li, Guangdong (CN); Weiguo Zhao, Guangdong (CN)

(73) Assignee: TENCENT TECHNOLOGY (SHENZHEN) COMPANY LIMITED, Guangdong (CN)

(21) Appl. No.: 14/484,652

(22) Filed: Sep. 12, 2014

Related U.S. Application Data
(63) Continuation of application No. PCT/CN2013/076948, filed on Jun. 7, 2013.

(30) Foreign Application Priority Data
Jun. 11, 2012 (CN) 201210190831.0

(51) Int. Cl. G06F 21/57; G06F 21/81; G06F 21/56

(52) U.S. Cl. CPC G06F 21/57; G06F 21/56; G06F 21/81
USPC 726/23

(57) ABSTRACT

A method for controlling closing of a terminal including: intercepting a shutdown operation; carrying out corresponding safety detection according to preset safety detection items; and processing potential safety hazards and closing the terminal after the processing. According to the method, the potential safety hazards of the terminal are processed before the terminal is closed, so that the terminal safety is improved. In addition, a system for controlling closing of a terminal and a computer storage medium are provided.

### CROSS REFERENCE TO RELATED APPLICATIONS

This application is a continuation application of PCT International Application No. PCT/CN2013/076948, filed on Jun. 7, 2013, entitled “METHOD AND SYSTEM FOR CONTROLLING CLOSING OF TERMINAL, AND COMPUTER STORAGE MEDIUM”, which claims the priority from Chinese patent application No. CN 201210190831.0, filed on Jun. 11, 2012. The above-referenced applications are hereby incorporated herein by reference in their entireties.

### FIELD

The present disclosure relates to the field of safety detection technology, and more particularly, to a method and system for controlling closing of a terminal, and a computer storage medium.

### BACKGROUND

Closing of a terminal is generally controlled by an operation system of the terminal. A traditional method for controlling closing of a terminal usually includes popping up a dialog box including options of standby, shutdown and restart when a shutdown command is detected; and directly closing the terminal when a user selects shutdown.

Often there will be some potential safety hazards in a terminal when the terminal has been used for some time. Such potential safety hazards include, for example, Trojan invasion, existence of system vulnerability, existence of software needing to be upgraded, etc. However, in such a traditional method for controlling closing of a terminal, since the terminal is directly closed, the terminal is likely to be in an insecure environment when operating next time, and starting speed, operating speed, and the like of the terminal in the next time will be affected.

### SUMMARY

Based on the above, it is necessary to aim at the problem that a traditional method for controlling closing of a terminal will affect the next time running safety of the terminal, to provide a method for controlling closing of a terminal wherein the method is capable of enhancing safety.

According to an aspect of the present disclosure, a method for controlling closing of a terminal includes: intercepting a shutdown operation; carrying out corresponding safety detection according to preset safety detection items; and processing potential safety hazards and closing the terminal after the processing.

In addition, it is also necessary to provide a system for controlling closing of a terminal wherein the system is able to enhance safety.

According to another aspect of the present disclosure, a system running on a terminal for controlling closing of the terminal includes an intercept module configured to intercept a shutdown operation; a safety detection module configured to carry out corresponding safety detection according to preset safety detection items; and a safe shutdown module configured to process potential safety hazards and close the terminal after the processing.

Moreover, it is also necessary to provide one or more computer storage medium which can enhance safety.

According to yet another aspect of the present disclosure, it provides one or more computer storage medium containing a computer executable command for executing a method for controlling closing of a terminal, wherein the method comprises: intercepting a shutdown operation; carrying out corresponding safety detection according to preset safety detection items; and processing potential safety hazards and closing the terminal after the processing.

The above-mentioned method and system for controlling closing of a terminal, and the computer storage medium, can intercept a shutdown operation when the terminal is being shutdown, carry out safety detection according to preset safety detection items, and process potential safety hazards and close the terminal after the processing. Since potential safety hazards are processed before a terminal is closed, the safety of the terminal can be enhanced, so that the terminal can be in a safer environment in the next run, and the starting speed, running speed, etc. of the terminal can also been improved.

### BRIEF DESCRIPTION OF THE DRAWINGS

FIG. 1 shows a flow chart of a method for controlling closing of a terminal according to one embodiment of the present disclosure;

FIG. 2 schematically shows a safe shutdown selection interface in an operation system according to one embodiment of the present disclosure;

FIG. 3 schematically shows a safe shutdown operation interface in an operation system according to one embodiment of the present disclosure;

FIG. 4 schematically shows a safe shutdown processing interface in an operation system according to one embodiment of the present disclosure;

FIG. 5 shows a structural block diagram of a system for controlling closing of a terminal according to one embodiment of the present disclosure;

FIG. 6 shows a structural block diagram of a safe shutdown module according to one embodiment of the present disclosure; and

FIG. 7 shows a structural block diagram of a safe shutdown module according to another embodiment of the present disclosure.

### DETAILED DESCRIPTION

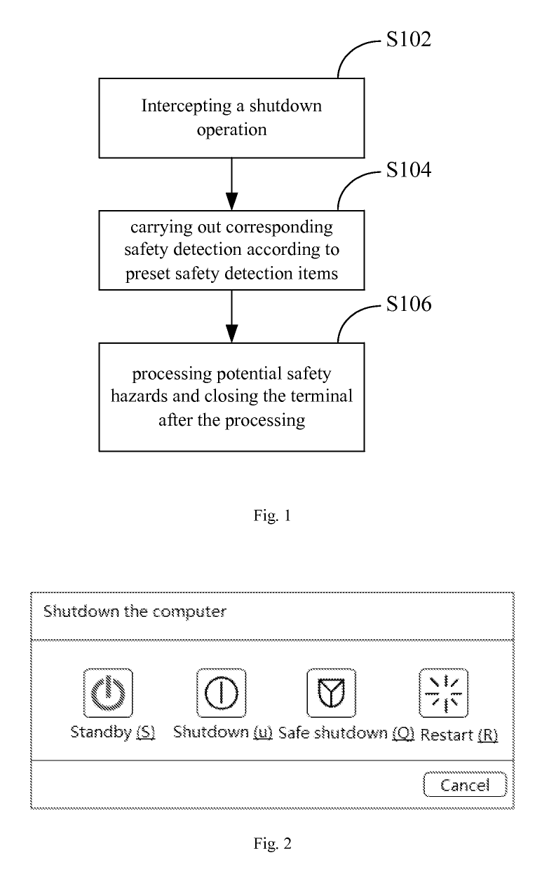

As shown in FIG. 1, in one embodiment, a method for controlling closing of a terminal includes the following steps:

Step S102, intercepting a shutdown operation.

Further, in one embodiment, when a shutdown operation is triggered, it needs to intercept a shutdown process, call a safety detection process, perform safety detection by a safety detection process, reactivate the shutdown process after completing the safety detection and process potential safety hazards in the terminal, and thereby close the terminal.

In one embodiment, a shutdown operation can be intercepted once a shutdown command is detected. The intercept mode is a mode of automatically intercepting, that is, a shutdown operation is intercepted immediately when a user triggers shutdown.

In another embodiment, when a shutdown command is detected, a safe shutdown selection interface will be entered, then a safe shutdown command will be acquired by the safe shutdown selection interface, and thereby a shutdown operation can be intercepted. Specifically, the safe shutdown command may be a command generated by a safe shutdown drop-down list item or a safe shutdown button or a safe shutdown extended menu item selected via the safe shutdown selection interface. The intercept mode is a mode of user trigger intercepting, that is, a user should select a preset safe shutdown drop-down list item or a preset safe shutdown button or a preset safe shutdown extended menu item to intercept a shutdown operation.

Preferably, for different operation systems run on a terminal, there are different setting modes of safe shutdown options. For example, a safe shutdown selection interface may be generated by inserting a safe shutdown button into an existing terminal shutdown selection interface. Further, a dialog function called by HOOK may be used to change an incoming dialog template resource and modify window procedure function, so as to accomplish the construction of a button of safe shutdown entry and a response thereto.

FIG. 2 illustrates a safe shutdown selection interface in an operation system. When a shutdown command triggered by a user is detected, the safe shutdown selection interface is entered. The safe shutdown selection interface contains a preset safe shutdown button which may be clicked by the user to intercept a shutdown operation. For other types of operation systems (e.g. android, Mac OS, etc.), a safe shutdown drop-down list item or a safe shutdown extended menu item may be created in the safe shutdown selection interface.

Step S104, carrying out corresponding safety detection according to preset safety detection items.

In one embodiment, the preset safety detection items may comprise at least one of Trojan killing, garbage cleaning, traces removing, bug fixing, safety examining and software upgrading.

Different safety detections may be set corresponding to different safety detection items. Specifically, in one embodiment, the step S104 includes reading and/or scanning a registry according to preset safety detection items; and/or scanning key positions of the terminal according to preset safety detection items.

For some of the safety detection items, a registry needs to be read. For instance, when the preset safety detection items include a software upgrade, a software registry should be read to obtain current software version numbers, and determine whether a software needs to be upgraded based on its current software version number.

For some of the safety detection items, it needs to scan a registry and/or key positions of the terminal The key positions of the terminal include, but are not limited to, positions in folders, registries where Trojan viruses often exist, folders generated by common software garbage, etc. The key positions may be set correspondingly when setting the safety detection items. For instance, when the preset safety detection items includes Trojan killing, it needs to scan a registry and/or terminal key positions, and a scanning result can be generated when a Trojan virus is scanned. When the preset safety detection items include garbage cleaning, it needs to scan folders generated by common software garbage to obtain scanned garbage files, and then to generate a scanning result.

Step S106, processing potential safety hazards and closing the terminal after the processing.

In one embodiment, the step S106 specifically includes: acquiring, according to a preset correspondence relationship between a safety detection result and a safe shutdown mode, a safe shutdown mode corresponding to a result obtained by the safety detection; and displaying the safe shutdown mode via a safe shutdown operation interface.

In the present embodiment, it is preset that different safety detection results correspond to different safe shutdown modes. For example, when a Trojan virus is scanned, a user may be reminded not to close the terminal until the killing of Trojan virus has been completed; when it is detected that there is an updated version of a software, the user may be reminded not to close the terminal until the upgrading of the software has been completed; when it is detected that there is a bug existing in the operation system, the user may be reminded not to close the terminal until the bug fixing has been completed; when it is detected that there is a garbage file in a key position of the terminal, the user may be reminded not to close the terminal until the garbage file has been removed; and so on. Further, the safe shutdown mode may be displayed on a safe shutdown operation interface.

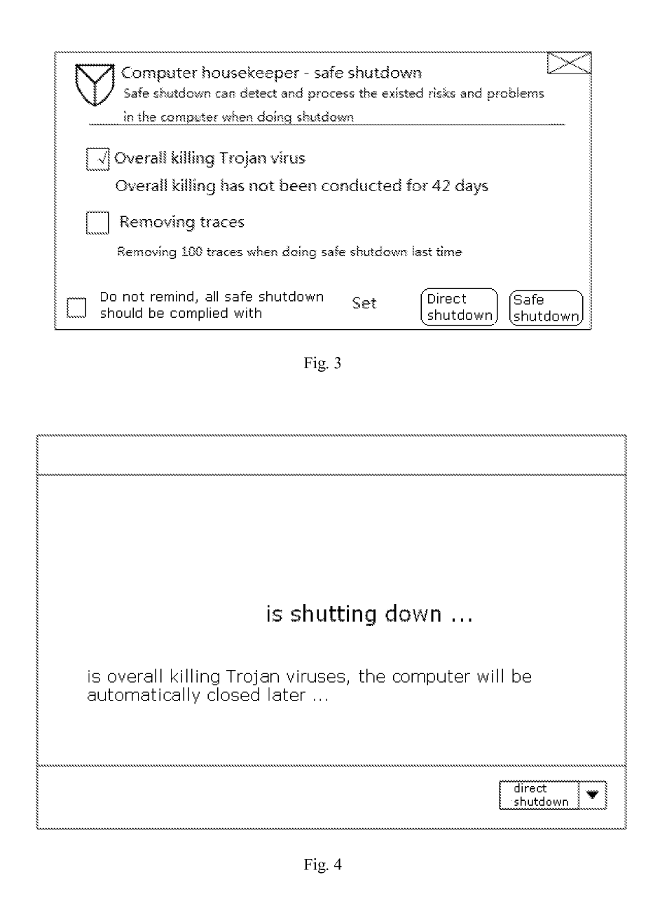

FIG. 3 shows a safe shutdown operation interface of an operation system. Safe shutdown modes corresponding to acquired and generated safety detection results, including options of overall killing Trojan viruses and removing traces, are displayed on the safe shutdown operation interface. A user may select an appropriate safe shutdown mode and click a safe shutdown button, so that potential safety hazards can be processed according to the safe shutdown mode selected by user.

In one embodiment, the step S106 further includes acquiring a safe shutdown mode selected by a safe shutdown operation interface, and processing safety hazards according to the safe shutdown mode selected and closing the terminal after the processing.

As shown in FIG. 3, when the user selects the option of overall killing Trojan virus and clicks the safe shutdown button, overall Trojan virus killing will be performed in the terminal, and the terminal will be closed after the killing. When the user clicks the safe shutdown button, since the terminal will be automatically closed after the Trojan virus killing, the operation of other applications in the terminal will not be affected, and the user's time will not be wasted either.

In one embodiment, a direct shutdown button may be provided on a safe shutdown operation interface; when a user clicks the direct shutdown button, the safe shutdown mode will be skipped, and the terminal will be controlled to be directly closed. As shown in FIG. 4, during the processing of potential safety hazards in the terminal, the user may be reminded by a safe shutdown processing interface that safety hazards are being processed, and the terminal will be automatically closed after the processing. The safe shutdown processing interface may be provided with a direct shutdown option which facilitates the user to interrupt the processing and directly close the terminal. It should be noted that, FIG. 4 only illustrates a safe shutdown processing interface according to one embodiment; it cannot be used to limit the present disclosure.

In another embodiment, the step S106 may further include automatically selecting, if it is detected that a selected safe shutdown mode is not acquired within a set time, a safe shutdown mode after the set time; and processing safety hazards according to the safe shutdown mode selected and closing the terminal after the processing.

The set time may be 10 seconds, 15 seconds, 20 seconds, or 1 minute, or others. In the present embodiment, after displaying the safe shutdown mode on the safe shutdown operation interface, if the user has not selected safe shutdown in the set time, the safe shutdown mode will be automatically selected based on a default setting. As shown in FIG. 3, overall killing Trojan virus and/or removing traces may be automatically selected to perform Trojan virus overall killing and traces removing on the terminal; the terminal will be closed after the killing and removing.

In one embodiment, a safe shutdown mode may be automatically selected for a user according to a default setting, and let the user confirm whether the shutdown should be performed according to the safe shutdown mode automatically selected by the default setting.

Specifically, a set interface of a default setting may be provided in the safe shutdown operation interface, the user may set a default safe shutdown mode via the set interface, and when it is detected that a user selected safe shutdown mode is not acquired within a set time, the safety hazards will be processed according to the safe shutdown mode in the default setting and the terminal will be closed after the processing.

In one embodiment, an option of always recommending shutdown under safe shutdown mode may be provided in the safe shutdown operation interface. As shown in FIG. 3, when the user selects the option of “Do not remind, all safe shutdown should be complied with”, then, if a shutdown operation is intercepted by the terminal at a later time, the terminal will automatically select a corresponding safe shutdown mode for the user according to the safety detection result without needing the user to participate the selection. According to the present embodiment, it may automatically perform a safety detection on the terminal and process the safety hazards without needing the user to initiate the safety detection, which saves the user's operating cost and operating time.

As shown in FIG. 5, in one embodiment, a system for controlling closing of a terminal includes an intercept module 100, a safety detection module 200, and a safe shutdown module 300, wherein:

The intercept module 100 may be configured to intercept a shutdown operation.

Further, in one embodiment, the intercept module 100 may intercept the shutdown process when a shutdown operation is triggered. A safety detection process may be called by the safety detection module 200, a safety detection may be performed by the safety detection process, and after completing the safety detection and processing potential safety hazards in the terminal, the safe shutdown module 300 may reactivate the shutdown process and thereby close the terminal.

In one embodiment, the intercept module 100 may be configured to intercept a shutdown operation once a shutdown command is detected. The intercept mode may be a mode of automatically intercepting, that is, a shutdown operation will be intercepted immediately when a user triggers shutdown.

In another embodiment, the intercept module 100 may be configured to enter a safe shutdown selection interface when a shutdown command is detected, acquire a safe shutdown command by the safe shutdown selection interface, and thereby to intercept a shutdown operation. Specifically, the safe shutdown command may be a command generated by a safe shutdown drop-down list item or a safe shutdown button or a safe shutdown extended menu item selected via the safe shutdown selection interface. The intercept mode may be a mode of user trigger intercepting, that is, a user should select a preset safe shutdown drop-down list item or a preset safe shutdown button or a preset safe shutdown extended menu item to intercept a shutdown operation.

The safety detection module 200 may be configured to carry out corresponding safety detection according to preset safety detection items.

In one embodiment, the preset safety detection items may comprise at least one of Trojan killing, garbage cleaning, traces removing, bug fixing, safety examining and software upgrading.

Different safety detections may be set corresponding to different safety detection items. Specifically, in one embodiment, the safety detection module 200 is configured to read and/or scan a registry according to preset safety detection items; and/or scan key positions of the terminal according to preset safety detection items.

The safe shutdown module 300 may be configured to process potential safety hazards and close the terminal after the processing.

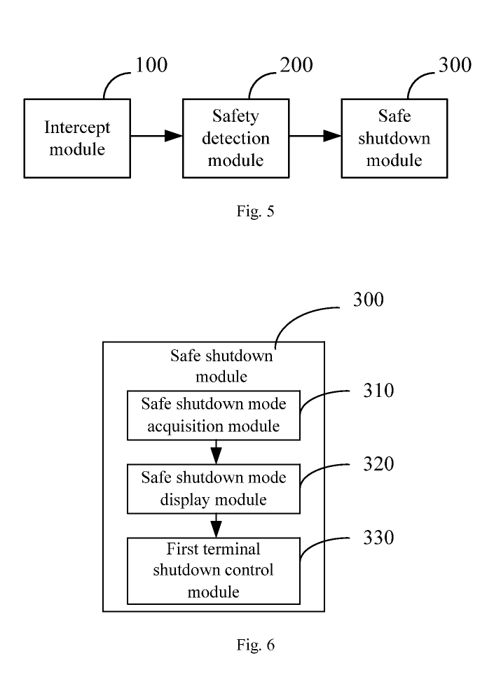

In one embodiment, as shown in FIG. 6, the safe shutdown module 300 may include a safe shutdown mode acquisition module 310, a safe shutdown mode display module 320 and a first terminal shutdown control module 330.

The safe shutdown mode acquisition module 310 may be configured to acquire, according to a preset correspondence relationship between a safety detection result and a safe shutdown mode, a safe shutdown mode corresponding to a result obtained by the safety detection.

The safe shutdown mode display module 320 may be configured to display the safe shutdown mode via a safe shutdown operation interface.

The first terminal shutdown control module 330 may be configured to acquire a safe shutdown mode selected via the safe shutdown operation interface; and process safety hazards according to the safe shutdown mode selected and close the terminal after the processing.

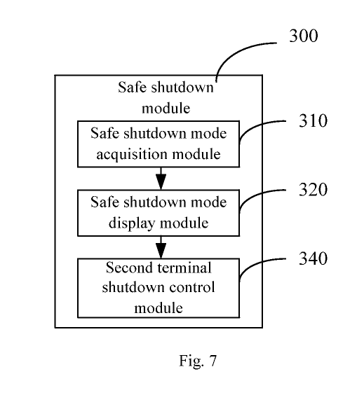

In another embodiment, as shown in FIG. 7, other than the above-mentioned safe shutdown mode acquisition module 310 and safe shutdown mode display module 320, the safe shutdown module 300 may further includes a second terminal shutdown control module 340.

The second terminal shutdown control module 340 may be configured to automatically select, if it is detected that a selected safe shutdown mode is not acquired within a set time, a safe shutdown mode after the set time; and process safety hazards according to the safe shutdown mode selected and close the terminal after the processing.

In yet another embodiment, the safe shutdown module 300 may include the safe shutdown mode acquisition module 310, the safe shutdown mode display module 320, the first terminal shutdown control module 330 and the second terminal shutdown control module 340 at the same time.

In one embodiment, an option of always recommending shutdown under safe shutdown mode may be provided in the safe shutdown operation interface. Then, if a shutdown operation is intercepted by the terminal at a later time, the terminal will automatically select a corresponding safe shutdown mode for the user according to the safety detection result without needing the user to participate the selection. According to the present embodiment, it may automatically perform safety detection on the terminal and process the safety hazards without needing the user to initiate the safety detection, which saves the user's operating cost and operating time.

According to the above-mentioned method and system for controlling closing of a terminal, since potential safety hazards are processed before a terminal is closed, the safety of the terminal can be enhanced, so that the terminal can be in a safer environment in the next run, and the starting speed, running speed, etc. of the terminal can also been improved.

In addition, since the processing of potential safety hazards may take some time, and processing when closing the terminal will not affect the operation of other applications in the terminal, therefore, with respect to the traditional mode that a user initiates a safety detection when detecting potential safety hazards exist in the terminal, the mode of processing potential safety hazards before closing of the terminal and automatically closing the terminal after the processing will save time and cost.

For different operation systems, a safe shutdown drop-down list item or a safe shutdown button or a safe shutdown extended menu item may be created in the safe shutdown selection interface to realize a shutdown operation. Therefore, the above-mentioned method and system for controlling closing of a terminal may be adapted to various operation systems (e.g. Windows, android, Mac OS, etc.) running on various terminals (e.g. personal computer, mobile phone, tablet PC, etc.).

Furthermore, easy-of-use has been improved by providing a safe shutdown selection interface and a safe shutdown operation interface; a user can select various safe shutdown modes via the safe shutdown operation interface, and can set that subsequent safe detections during the closing of the terminal do not need the user to participate, which saves the user's operating cost and time, and improves the user's experience needs.

It should be noted that for a person skilled in the art, partial or full processes to realize the methods in the above embodiments can be accomplished by related hardware instructed by a computer program. The program can be stored in a computer readable storage medium and the program can include the processes of the embodiments of the above methods. Wherein, the storage medium can be a disk, a light disk, a Read-Only Memory or a Random Access Memory, etc.

The embodiments are chosen and described in order to explain the principles of the disclosure and their practical application so as to allow others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for controlling closing of a terminal, comprising:
intercepting a shutdown operation;
carrying out corresponding safety detection according to preset safety detection items; and
processing potential safety hazards and closing the terminal after the processing.

2. The method of claim 1, wherein the intercepting the shutdown operation includes intercepting a shutdown operation when a shutdown command is detected.

3. The method of claim 1, wherein the intercepting the shutdown operation comprises:
entering a safe shutdown selection interface when a shutdown command is detected;
acquiring a safe shutdown command through the safe shutdown selection interface; and
intercepting the shutdown operation.

4. The method of claim 1, wherein the preset safety detection items comprise at least one of Trojan killing, garbage cleaning, traces removing, bug fixing, safety examining and software upgrading.

5. The method of claim 4, wherein the carrying out the corresponding safety detection according to the preset safety detection items comprises:
perform at least one of:
at least one of reading and scanning a registry according to the preset safety detection items; and
scanning key positions of the terminal according to the preset safety detection items.

6. The method of claim 1, wherein the processing the potential safety hazards and closing the terminal after the processing comprises:
acquiring, according to a preset correspondence relationship between a safety detection result and a safe shutdown mode, a safe shutdown mode corresponding to a result obtained by the safety detection; and
displaying the safe shutdown mode by a safe shutdown operation interface.

7. The method of claim 6, wherein the processing the potential safety hazards and closing the terminal after the processing further comprises:
acquiring the safe shutdown mode selected via the safe shutdown operation interface; and
processing safety hazards according to the safe shutdown mode selected and closing the terminal after the processing.

8. The method of claim 6, wherein the processing the potential safety hazards and closing the terminal after the processing further comprises:
automatically selecting, when it is detected that a selected safe shutdown mode is not acquired within a set time, the safe shutdown mode after the set time; and
processing safety hazards according to the safe shutdown mode selected and closing the terminal after the processing.

9. A system running on a terminal for controlling closing of the terminal, comprising:
an intercept module configured to intercept a shutdown operation;
a safety detection module configured to carry out corresponding safety detection according to preset safety detection items; and
a safe shutdown module configured to process potential safety hazards and close the terminal after the processing.

10. The system of claim 9, wherein the intercept module is configured to intercept the shutdown operation when a shutdown command is detected.

11. The system of claim 9, wherein the intercept module is configured to enter a safe shutdown selection interface when a shutdown command is detected, acquire a safe shutdown command through the safe shutdown selection interface, and intercept the shutdown operation.

12. The system of claim 9, wherein the preset safety detection items comprise at least one of Trojan killing, garbage cleaning, traces removing, bug fixing, safety examining and software upgrading.

13. The system of claim 12, wherein the safety detection module is configured to perform at least one of reading and scanning a registry according to the preset safety detection items, and scan key positions of the terminal according to the preset safety detection items.

14. The system of claim 9, wherein the safe shutdown module comprises:
a safe shutdown mode acquisition module configured to acquire, according to a preset correspondence relationship between a safety detection result and a safe shutdown mode, the safe shutdown mode corresponding to a result obtained by the safety detection; and
a safe shutdown display module, configured to display the safe shutdown mode via a safe shutdown operation interface.

15. The system of claim 14, wherein the safe shutdown module further comprises:
a first terminal shutdown control module configured to acquire the safe shutdown mode selected by the safe shutdown operation interface; and process safety hazards according to the safe shutdown mode selected and close the terminal after the processing.

16. The system of claim 14, wherein the safe shutdown module further comprises:
a second terminal shutdown control module configured to automatically select, when it is detected that a selected safe shutdown mode is not acquired within a set time, the safe shutdown mode after the set time; and process safety hazards according to the safe shutdown mode selected and close the terminal after the processing.

17. One or more computer storage medium containing a computer executable command for executing a method for controlling closing of a terminal, wherein the method comprises:
intercepting a shutdown operation;
carrying out corresponding safety detection according to preset safety detection items; and
processing potential safety hazards and closing the terminal after the processing.
